(19) United States
(12) Patent Application Publication
(10) Pub. No.: US 2026/0267557 A1
(43) Pub. Date: Sep. 10, 2026

(54) STORAGE APPLICATION OFFLOAD

(71) Applicant: MELLANOX TECHNOLOGIES, LTD., Yokneam (IL)

(72) Inventors: Ziv Waksman, Maccabim (IL); Eliav Bar-Ilan, Or Akiva (IL); Oren Duer, Kohav Yair (IL); Maxim Gurtovoy, Tel Aviv (IL)

(21) Appl. No.: 19/075,497

(22) Filed: Mar. 10, 2025

(51) Int. Cl. G06F 3/06

(52) U.S. Cl. CPC G06F 3/0659; G06F 3/061; G06F 3/067

(57) ABSTRACT

Systems and methods disclosed herein are for a data-path accelerator (DPA) to be in communication with a kernel-based peer to peer (P2P) process of a host machine and with multiple networked storage devices, and to allow the DPA to handle storage queues and input-output (IO) requests from an initiator component for the networked storage devices. The kernel-based P2P process may allow direct communication between the DPA and the networked storage devices for data underlying the IO requests.

### TECHNICAL FIELD

This disclosure generally pertains to handling of storage applications in a computer environment and specifically pertains to using a data-path accelerator with the storage applications.

### BACKGROUND

A central processing unit (CPU) of a host machine or node may handle storage queues and input/output (IO) requests for a storage application and for a data processing unit (DPU) performing the storage application. When the CPU handles storage queues and IO requests, the DPU may be occupied. The DPU being occupied may prevent it from being able to perform other operations. The DPU being occupied may cause latencies for the storage applications and other related applications. The DPU being occupied may also cause an increase in power consumption in a host machine.

### BRIEF DESCRIPTION OF DRAWINGS

FIG. 1A illustrates a system that is subject to embodiments for storage application offload to a data-path accelerator (DPA);

FIG. 1B illustrates a further system that is subject to embodiments for storage application offload to a DPA;

FIG. 2A illustrates host machine aspects for storage application offload using a kernel-based peer to peer (P2P) process, according to at least one embodiment;

FIG. 2B illustrates data processing unit (DPU) aspects for storage application offload using a DPA, according to at least one embodiment;

FIG. 3A illustrates exchanges that are part of a storage application offload using a DPA in communication with a kernel-based P2P process, according to at least one embodiment;

FIG. 3B illustrates data handling aspects by multiple handlers operating in a many-to-many (MTM) pipelining configuration as part of a storage application offload, according to at least one embodiment;

FIG. 4 illustrates computer and processor aspects of a system for storage application offload using a DPA in communication with a kernel-based P2P process, according to at least one embodiment;

FIG. 5 illustrates a process flow in a system for storage application offload using a DPA in communication with a kernel-based P2P process, according to at least one embodiment;

FIG. 6 illustrates yet another process flow in a system for storage application offload using a DPA in communication with a kernel-based P2P process, according to at least one embodiment;

FIG. 7 illustrates a further process flow in a system for storage application offload using a DPA in communication with a kernel-based P2P process, according to at least one embodiment; and

FIG. 8 illustrates an example datacenter to apply at least one embodiment in FIGS. 1A-7.

### DETAILED DESCRIPTION

Storage application offloading may be performed in a data-path accelerator (DPA), which may be a sub-system of a data processing unit (DPU). The DPA may be distinct from a central processing unit (CPU) and may also be distinct from any other DPU of a host machine. In one example, the DPA may be part of a DPU that is part of a peripheral component interconnect (PCI) communication with the host machine and physically separate from the host machine. In another example, the DPA may be provided on a circuit board with its own network interface card (NIC). The DPA may be able to handle IO (input-output such as read and write) requests involving a target application (such as a DOCA application) that may otherwise involve a CPU and storage devices attached to a PCI bus. The storage application offloading described here may reduce the workload of the CPU or its associated DPU by having storage queues of the host machine handled by the DPA and having the IO requests for data also handled or communicated directly between the DPA and the storage devices. The direct handling or communication between the DPA and the storage devices may be based in part on a kernel-based peer-to-peer (P2P) process between the DPA and the storage devices.

The storage queues, along with a staging buffer, can handle data associated with the IO requests of a Non-Volatile Memory Express (NVMe®) over Fabrics (NVMf or NVMof®) protocol, such as implemented in an NVMf target DOCA application. Nvidia's DOCA provides a Datacenter-On-Chip Architecture (DOCA®) framework which may be applicable in the descriptions herein. For instance, the NVMf target DOCA application may be associated with an offloading engine enabled by DOCA libraries and using a DOCA Application Programming Interface (API) of the DOCA libraries. The DOCA API may be fully in the userspace (such as part of the host machine) or may have a part thereof (or may be fully) deployed on the DPA to enable developers to generate further storage solutions without CPU interference.

The DOCA API can enable multiple handlers in the DPA. The multiple handlers can receive the IO requests and can enable transfer of data to and from a storage device via a PCI bus using a staging buffer and using storage queues to indicate completions for an initiator of the IO requests. Individual handlers may be assigned to individual queues by an aspect of the DOCA libraries. The storage devices and the DPA may communicate with each other via the kernel-based P2P process which exposes the base registers (BARs) of the storage devices, via the userspace, to an IO driver capable of communicating the IO requests. The IO driver may be a Remote Direct Memory Access (RDMA) driver. The userspace can provide a virtual function (VF) that can cause VFIO drivers in the kernel to expose the BARs for the IO driver, for example.

The multiple handlers can operate in a many-to-many (MTM) pipelining configuration. The multiple handlers may include a transmit (Tx) handler, a completion (CQ) handler, and a backend (BE) handler. In the MTM pipelining configuration, each of at least the Tx and the CQ handlers may be assigned to multiple queues operating at a same performance threshold (such as same Tx handler speed). The storage application offloading herein may be able to address situations where a DPU may be tied up from being able to perform other operations, when a CPU of a host machine or node handles storage queues and IO requests. For example, when a CPU of a host machine or node handles storage queues and IO requests, may be issues of latency and increased power consumption in the host machine. The storage application offloading herein may use the DPA to offload the handling of storage queues and IO requests from the CPU, along with the MTM pipelining configuration of the DPA handlers to address the problem.

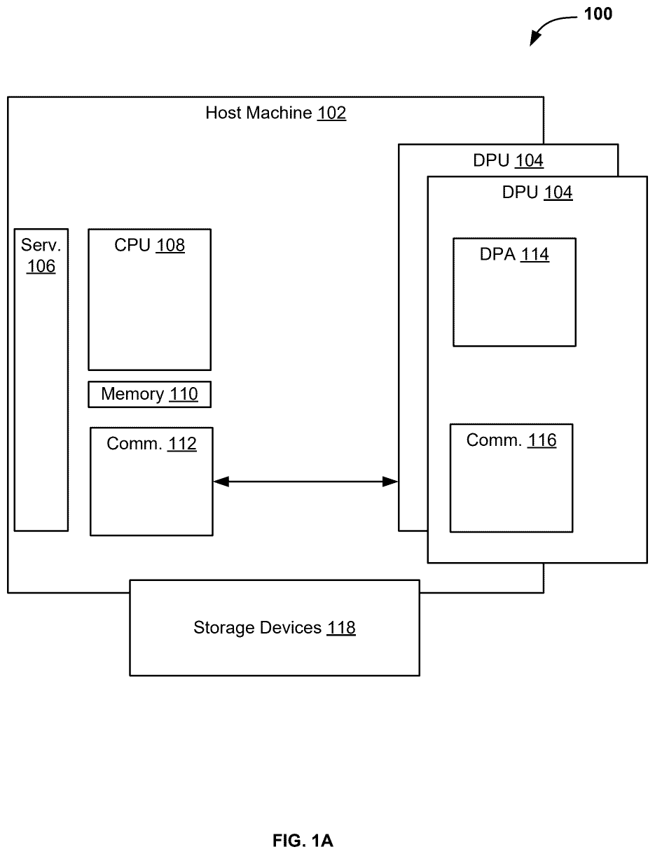

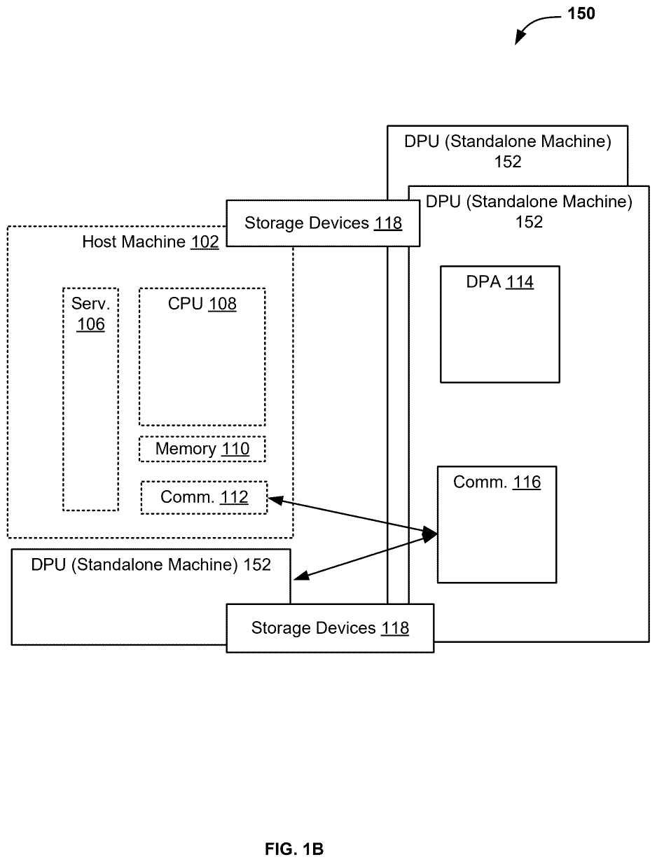

FIG. 1A illustrates a system 100 that is subject to embodiments for storage application offload to a DPA. The system 100 may include one or more DPUs 104 that may be associated with a CPU 108 of a host machine 102. The DPUs are also referred to herein as DPU cards unless indicated otherwise. Workload, as used herein, is in reference to data, applications, or programs to be executed, processed, or performed using one or more CPUs, graphics processing units (GPUs), or DPUs. The workload may pertain to a storage application and may include networking and communication requirements (for data transfer), data reduction (for compression/decompression), data security and analytics (for cryptography), and data processing, generally.

Workload portions for a storage application may be performed across multiple storage devices 118. The DOCA framework may be applied to at least one DPU 104 that can perform storage application offload from a CPU 108 to a DPA 114. As used herein, an application under the DOCA framework may be referred to as a DOCA application or DOCA target application. When the Non-Volatile Memory Express (NVMe®) over Fabrics (NVMf or NVMof®) protocol is used with a DOCA application, the resulting storage application 202 may be an NVMf target DOCA application. Unless noted otherwise, the storage application offloading herein is with respect to a storage application 202 that may be a DOCA application or that may specifically be an NVMf target DOCA application. At least the NVMf target DOCA application is in reference to a software aspect in a computer environment that can allow storage devices 118 or a host machine 102 to expose its storage capacity and functionality of its storage devices 118 over a network using the NVM Express or NVMf protocol. The access to the storage capacity and functionality supports, in part, the storage application offloading herein.

In one example, storage application offloading in a DPA 114 may allow the DPA 114, as a subsystem of a DPU 104, to perform certain storage-related tasks otherwise handled by a CPU 108. A DPA 114 may be provided in at least one DPU 104 and may be distinct from the CPU 108 or from any other DPU of a host machine 102. In one example, the DPA 114 may be part of (or perform functions as part of) a DPU 104 that is in a peripheral component interconnect (PCI) communication with the host machine 102 and may be physically separate from or physically together with the host machine 102. In another example, the DPA 114 may be provided on a circuit board with its own network interface card (NIC). The DPA 114 can handle input-output (IO) requests (such as read, write, send, and the like) involving a storage application 202. Such IO requests may otherwise involve a CPU and may involve one or more storage devices attached to a PCI bus.

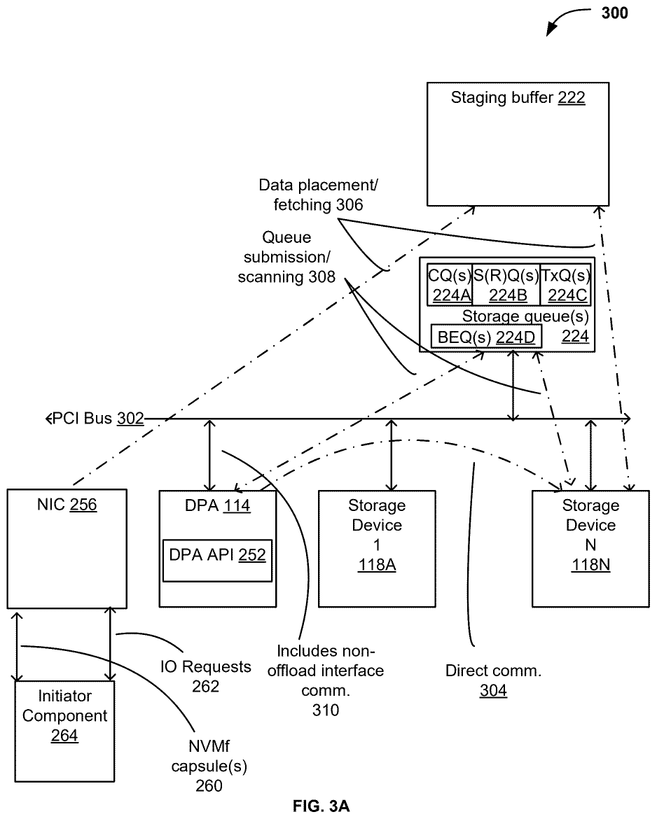

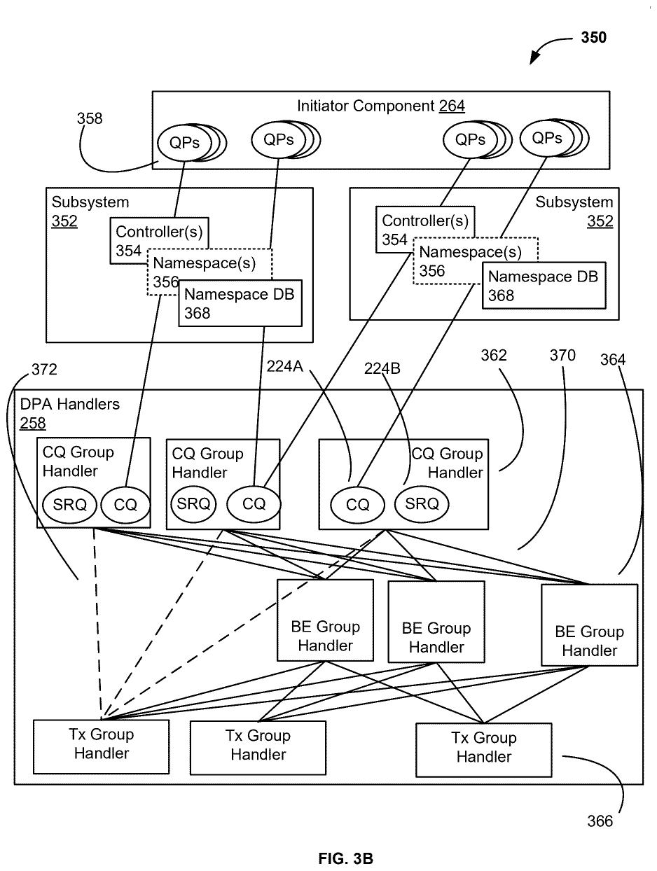

The storage application offloading herein may reduce the workload of the CPU 108 or its associated DPU by having storage queues of the host machine 102 handled by the DPA 114 and by having IO requests for data also handled or communicated directly between the DPA 114 and the storage devices 118. The direct handling or communication between the DPA and the storage devices may be based in part on a kernel-based peer-to-peer (P2P) process (as in FIG. 3B) between the DPA 114 and the storage devices 118. The storage queues, along with a staging buffer, can handle data associated with the IO requests of the storage application. For instance, the storage application may be associated with an offloading engine allowed, in part, by DOCA libraries, handlers (software or code blocks capable of handling data moved in and out of queues) and using a DOCA application programming interface (API) of the DOCA libraries. The DOCA API may be fully in a userspace (such as part of a host machine) or may have a part thereof (or may be fully) deployed on the DPA 114 to allow developers to generate further storage solutions without CPU interference.

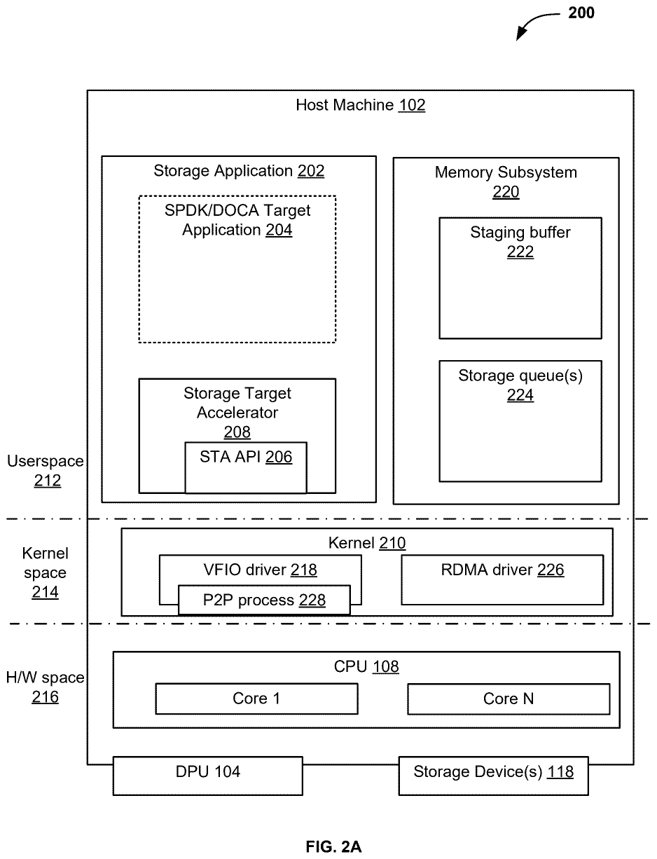

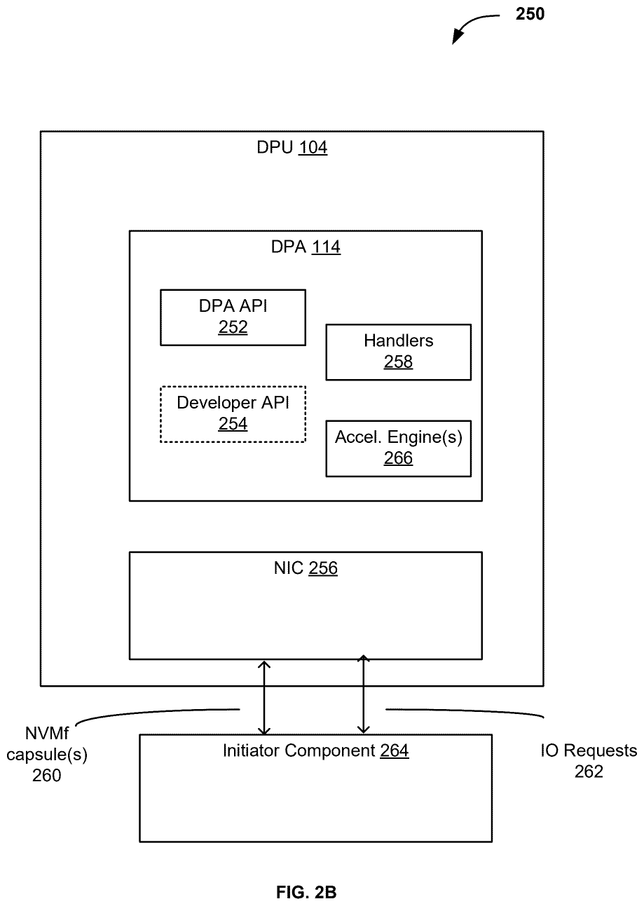

The DOCA API may allow multiple handlers (362-366 in FIG. 3B) in the DPA 114. The multiple handlers may receive the IO requests and may allow transfer of data to and from a storage device via a PCI bus, a staging buffer, and storage queues to indicate completions for an initiator component of the IO requests. The initiator component (264 in FIG. 2B) may be a software or hardware feature in the system 100. Individual handlers may be assigned to individual queues by an aspect of the DOCA libraries. The storage devices 118 and the DPA 114 may communicate with each other via the kernel-based P2P process which exposes the base registers (BARs) of the storage devices, via the userspace, to an IO driver capable of communicating the IO requests. The IO driver may be a Remote Direct Memory Access (RDMA) driver. The userspace can provide a virtual function (VF) that can cause VFIO drivers in the kernel to expose the BARs for the IO driver, for example.

In another example, the multiple handlers can operate in a many-to-many (MTM) pipelining configuration (370 in FIG. 3B). The multiple handlers may include a transmit (Tx) group handler, a completion (CQ) group handler, and a backend (BE) group handler, generally referred to as handlers unless stated otherwise. In the MTM pipelining configuration, each of at least the Tx and the CQ group handlers may be assigned to multiple queues operating at the same performance threshold (such as same or similar Tx handler speed, same or similar transmission queue speed, or same or similar completion speed). Use of the DPA to offload the handling of storage queues and IO requests from the CPU, along with the MTM pipelining configuration of the handlers, can address latencies that may otherwise exist for storage or other related applications The use of the DPA in this manner can also address the DPU being occupied and any related increase in power consumption in a host machine.

In at least one embodiment, a system 100 for storage application offload to a DPA may include multiple DPUs 104 that may at least one DPA 114 in one of the DPUs 104. In at least one embodiment, a DPU 104 used herein may be Nvidia's BlueField® DPU. Nvidia's DOCA®-related applications interface with a DOCA® library that may be associated with application programming interfaces (APIs) to allow storage applications for the BlueField® DPU. The DOCA® library may include a DOCA storage target accelerator (STA) library. The STA library may be able to abstract an underlying offload engine of the DPA 114. The STA library may be part of the STA 208 and may allow the STA API 206 for interaction therewith.

The STA library may also provide the STA API 206 for loading the offload application, for configuring the offload application, and for interacting with the offload application for error reporting, statistics, and non-offloaded traffic processing. The STA library may also use some aspects of the DOCA libraries, including DOCA_DPA, DOCA_RDMA, the DOCA_CORE, DOCA_STA, and DOCA_COMCH. In one example, the STA library (represented by DOCA_STA in DOCA) may allow a user, administrator, or developer of the storage application 202 to configure and communicate with an offload engine. The storage application 202 may interact with the STA library using the STA API 206. The STA library may include DOCA contexts that may be a DOCA STA control context and a DOCA STA IO context. The DOCA STA control context may be a single instance context and may be responsible for loading and configuring the offload engine (such as at least the handlers 258 in FIG. 2B). In addition, the DOCA STA control context may be responsible for handling asynchronous events reported by the offload engine and for initiating slow-path operations toward the offload engine. The slow-path operations may be through a control plane and may include operations to detach a namespace, to destroy a queue pair (QP), and other like operations. The DOCA STA IO context may be a per-thread IO channel for communicating with the offload engine. The DOCA STA IO context may include at least one pointer and can initiate control operations in the system 100. The DOC STA control context may be thread-safe and may need to protect critical sections using locks.

The system 100 may include a host machine 102 having a CPU 108, having memory 110, having a communications feature (comm.) 112, having a services feature (serv.) 106, and having an association with a DPU 104. The DPU 104 may be a single DPU having the DPA 114. There may be other DPUs, as illustrated, that may perform other functions for the host machine 102. The communications feature (comm.) 116 of the DPU 104 may be a network interface card (NIC) (as in FIG. 3A). The NIC may be used to communicate independently of the host machine's communications feature (comm.) 112. The communications features (comm.) 112, 116 in the system 100 may communicate there between as well. The communication features (comm.) 112, 116 may communicate based, at least in part, on a PCI or a PCIe (PCI express) standard. In at least one embodiment, the system 100 therefore includes at least one processor (such as a CPU 108) and memory 110 having instructions that when executed by the at least one processor (such as a CPU 108) causes the system to perform functions associated with storage application offload to a DPA. The CPU 108 may boot up to allow aspects of the DPU 104 to perform in a discovery phase to handle communication with storage devices 118 and independent of the CPU 108.

In one example, an initial configuration (or initialization) in the system 100 may be performed to allow the storage application offload and may include defining the NVMe target components based on configuration files in the memory 110 of the system 100. The initial configuration may include loading the kernel 210 from the memory 110 to perform the aspects described for storage application offloading. The initial configuration may also include defining subsystems 352 (in FIG. 3B) that may be associated with a kernel space 214 (in FIG. 2A) or a DPU 104 in the hardware space (or H/W space 216 in FIG. 2A), assigning NVMe namespaces to each subsystem, and defining NVM subsystem ports where each may be assigned to multiple subsystems. The initial configuration may include attributes for each of the NVM subsystem ports such as transport type (such as RDMA), Internet Protocol (IP) addresses, IP ports, and the like. In a further example, the discovery phase may include publishing subsystem information and topology to an initiator component 264 (in FIG. 2B) and performing a RDMA connect and establishing procedures for at least the initiator component 264 and the host machine 102. The discovery phase may include processing fabric connect commands, allocating controller resources, allocating RDMA QPs, and assigning each QP to a target port, subsystem, target controller, and queue identifier (ID).

FIG. 2A illustrates host machine aspects 200 for storage application offload using a kernel-based P2P process, according to at least one embodiment. A storage application 202 of a host machine 102 may be a DOCA or Storage Performance Development Kit (SPDK) target application, in one example. The DOCA or SPDK target application may run in the userspace 212 and outside a kernel space 214 but may interact with H/W space 216 in a direct manner. One or more of the DPUs 104 may be a hardware device that may be associated with the storage application 202. A Storage Performance Development Kit target (or DOCA or SPDK target application 204) within a storage application 202 may be in reference to a storage service or endpoint that may be exposed by the storage application 202. The DOCA or SPDK target application 204 may use capabilities of an SPDK, which may provide different target types, including the NVMf target part of the aforementioned NVMf target DOCA or SPDK target application.

The SPDK is an open-source framework for storage devices and may incorporate native tools and libraries for developers to create storage applications. The NVMf target of the SPDK presents NVMe devices as remote block devices over the NVMf protocols, which may include Remote Direct Memory Access (RDMA) and Transmission Control Protocol (TCP). While illustrated as part of a host machine 102, which may be a bare-metal host machine, the storage application offloading herein allows at least the DOCA or SPDK target application 204 to reside or be offloaded to a DPU 104. The DOCA or SPDK target application 204 may interact with the offload engine via an STA API 206 of the STA 208 in the host machine 102. The STA API 206 may be allowed to operate as described herein at least because of support by DOCA libraries of the STA 208, which provide some of the functions of the STA API 206. The host machine 102 may use a patched kernel 210 with the DPU 104. The kernel 210 may be a Linux® kernel. The patching to the kernel 210 may be to provide the P2P support for the userspace 212. In one example, the P2P support may be through a kernel-based P2P process 228 of the VFIO driver 218. The VFIO driver 218 may allow exposure of the BARs of the storage devices 118 of the H/W space 216, via the userspace 212, to an IO driver (such as an RDMA driver 226) that registers a memory region (MR) of the storage devices 118.

FIG. 2A also illustrates details associated with the memory subsystem 220 in support of the storage application offload herein. The memory subsystem 220 may include staging buffers 222 and storage queues 224 of the userspace 212, as associated with the IO requests. The DPU 104 that includes the DPA 114 may be in communication with the staging buffer 222 of the host machine 102 to handle data associated with the IO requests. The staging buffer 222 and the storage queues 224 may be associated with the CPU or a second DPU of the host machine 102 and may be used, in part, to retrieve and to provide data for read and write aspects of the IO requests. The storage queues 224 may include completion queues (CQs) 224A for status of completions associated with IO requests, submission queues (SQs) and shared receive queues (SRQs) 224B (also together referenced as S(R)Qs) for IO requests to be submitted to a storage device 1 to N 118A-118N (or for receive queues shared by multiple queue pairs), and to a Tx group handler 366 for managing transfer of data between the host machine 102 and the storage devices 1 to N 118A-118N.

In one example that uses RDMA, the storage queues 224 may be associated with QPs for the IO requests 262 related to communications between the storage devices and initiator components that may be external with respect to the host machine 102. The QPs may be a pair of queues. In one example, one queue may be for sending data, while another queue may be for receiving data, between a storage device and an initiator component. A queue for sending data may be able to store the data, represented by outgoing messages or data packets. When a ready indication is provided that a message is ready to be sent, the message may be added to the queue for sending data and may be an outgoing message therein. The initiator or storage device may process messages asynchronously to free a CPU 108 for other tasks. On the incoming side, a queue for receiving messages may be provided. The queue for receiving messages may store data represented by incoming messages or data packets. When a message arrives, it may be placed in the queue for receiving messages and a storage device or initiator component may notify a storage application that a new message is available.

FIG. 1B illustrates a system 150 that is subject to embodiments for storage application offload to a DPA. As illustrated, a DPU 152, in one example, may be a standalone machine. The standalone machine may be a Just-a-Bunch-of-Flash (JBOF) which has capability to perform as an independent host machine, without need for the illustrated host machine 102. The DPU 152 may include hardware (HW) accelerators that may be part of the DPA 114. The JBOF may use the DPU 152 to perform software applications, communications, and acceleration pertaining to networking, storage, and security functions. In one example, the DPU 152 may replace a host machine 102, including the CPU 108, communications feature (comm.) 112 (including PCIe features, accelerators, and other features), and memory features 110 (including DRAM). The DPU 152 may include storage software which may allow the JBOF to present as blocks, files, or object storage, for the storage devices 118. The DPU 152, with its DPA 114 and communications features 116, may be able to handle storage application offload among others DPUs (acting as other standalone machines) and among other host machines 102, if provided.

FIG. 2B illustrates DPU aspects 250 for storage application offload using a DPA, according to at least one embodiment. The DPU aspects 250 illustrate that a DPU 104 associated with storage application offload may include a DPA 114 associated with a DPA API 252. The DPA API 252 may perform queue submission and queue scanning for the storage queues 224 of the userspace 212. As the DPA API 252 may handle queue submission and queue scanning without interference or interaction with a CPU 108, there is direct communication established between the DPU 104 and the storage devices 118 for IO requests 262 (including IO requests within NVMf capsules 260). Further, in at least one example, the STA API 206 may be able to directly communicate with the DPA API 252 using PCIe communications. There may be a developer API 254 associated with the STA API 206 and allowed, in part, by the STA library. The developer API 254 may be part of the STA API 206 deployed on the DPA 114 to allow developers to generate further storage solutions, in addition to the storage application offload, without CPU interference.

The NIC 256 in the DPU 104 may represent one type of communication feature (comm.) 116 available to the DPU 104. The NIC 256 may allow the IO requests 262 from an initiator component 264 for data and may, separately, allow encapsulated communications using an NVMf protocol. For instance, a communication under the NVMf protocol may be an NVMf capsule 260 provided for information exchange. The NVMf capsule 260 may include NVMe commands, responses, and associated data associated with an IO request as a single and self-contained packet. An NVMf capsule may represent encapsulation of NVMe commands, responses, and data, for NVMe controllers and for host machines associated therewith. The NVMf capsules herein may be over RDMA or TCP. In one example, when an NVMf capsule 260 is received, an NVMe command of the NVMf capsule 260 may be retrieved and processed (which may include translation or conversion) to provide an appropriate IO request 262 for an underlying storage device 118. Therefore, all communications from an initiator component 264 may be subject to storage application offload. As used herein and unless otherwise indicated, all discussion to the IO requests 262 and for NVMf capsule 260 may be interchangeable unless otherwise indicated, at least because the NVMf capsules may include IO requests 262.

The DPU aspects 250 may include multiple handlers 258 (such as data handlers) that may receive the IO requests 262 from the NIC 256 and that may allow the transfer of data to and from a storage device 118 via a PCI bus. The transfer of data may be based in part on use of the staging buffer 222 for temporarily storing data to be transferred to and from the storage devices 118 and of the storage queues 224 to indicate completions for an initiator component 264 of the IO requests 262. Further, individual ones of the handlers 258 may be assigned to individual queues (detailed in at least FIG. 3B) by an aspect of the DOCA libraries. The handlers 258 may be allowed or supported, in part, by a software library (such as the DOCA library) of the host machine 102. The handlers 258, as detailed in FIG. 3B, may be able to handle the storage queues for the IO requests 262. The handlers 258 may be able to implement pipeline flows for an NVMf datapath processing pertaining to the NVMf capsules 260, using multiple accelerator (accel.) engines 266 of the DPA 114. Further, the handlers 258 may perform RDMA operations required as part of the NVMf protocol and for access to the storage devices 118.

FIG. 3A illustrates exchanges 300 that are part of a storage application offload using a DPA in communication with a kernel-based P2P process, according to at least one embodiment. The exchanges 300 include the use of the DPA 114 in communication, via a PCI bus 302 for instance, with a kernel-based P2P process 228 of a host machine 102. The solid lines indicate connections to the PCI bus 302 while the broken lines indicate communications that may occur through the connections to the PCI bus 302.

There may be multiple storage devices 1 to N 118A-118N provided for the host machine 102 and that are networked together to represent networked storage devices. The reference to networked storage devices herein may be with respect to the storage devices 1 to N 118A-118N being associated together using the PCI bus 302 but may also include such association performed using other protocols, including NVLink®. The DPA 114 can handle the storage queues 224 and the IO requests 262 from an initiator component 264 for the storage devices 1 to N 118A-118N. The kernel-based P2P process 228 may be used to allow a direct communication (comm.) 304 between the DPA 114 and the storage devices 1 to N 118A-118N for data underlying the IO requests 262. In one example, the direct communication (comm.) 304 is at least because the CPU is not involved in handling the IO requests 262 or the storage queues 224 for the host machine 102.

FIG. 3A illustrates that the NIC 256, the staging buffer 222, and the storage devices 1 to N 118A-118N are able to communicate with respect to data placement and data fetching 306 for data that may be based in part on IO requests 262 or the NVMf capsules 260 associated with the NIC 256. The DPA 114 may be able to communicate queue submission/scanning 308 with the storage queues 224 and the storage devices 1 to N 118A-118N. For instance, for read/write IO requests, for immediate NVMf capsules, and for RDMA read completions, the DPA 114 may need to prepare and submit a request for an NVMe submission queue entry (SQE). The SQE may be a data structure format with commands from the host machine 102 to a storage device 118. The commands may be regarding a specific backend queue (BEQ). In one example, the scanning may be in reference to a process for monitoring for completes with respect to IO requests (including NVMf capsules) and for provision of results from the completes to a completion queue. The host machine 102 can retrieve an NVMe based in part on the completion queue. There may be at least one non-offload interface (I/F) communications (comm.) 310 allowed between the DPA 114 and the DPA API 252 but may also extend to the developer API 254.

FIG. 3B illustrates data handling aspects 350 by multiple handlers operating in an MTM pipelining configuration as part of a storage application offload, according to at least one embodiment. The data handling aspects 350 may be allowed, in part, by messages that may be passed between handlers 362-366 using inter-thread communication software (S/W) queues. The S/W queues may include backend queues (BEQs) 224D. The BEQs 224D may be provided in the DPA 114 or other aspect of the DPU 104. The BEQs 224D may also be provided in the memory subsystem 220 of the host machine 102. The BEQs 224D may be distinct from the CQ, S(R)Q, and TxQ in the storage queues 224.

As illustrated, a DPA 114 of a DPU 104 may include multiple handlers 362-366 to handle the storage queues 224A-224D. The handlers 362-366 may operate in an MTM pipelining configuration in which one or more of the handlers 362-366 may be assigned to multiple ones of the storage queues 224A-224D. This assignment may be based in part on the multiple ones of the storage queues 224A-224D operating at the same performance threshold. The same performance threshold may include a same or similar Tx handler speed, a same or similar TxQ speed, a same or similar completion speed, or a slowest time for a completion.

The subsystems 352 may be associated with the kernel 210 and may incorporate one or more controllers 354 that may be NVMf target controllers. The subsystems 352 may include namespaces 356. Each of the subsystems 352 may be identified via an NVMe-qualified name (NQN). A subsystem port may be provided for each subsystem 352 and may be a logical object that may be bound to fabric-transport-specific ports in the system 100. The subsystem port may allow a networked fabric as illustrated in FIGS. 1A-3B to access the namespaces 356 attached to a specific subsystem 352 via a specific controller 354 (which may be an NVMf target controller).

The data handling aspects 350 include multiple handlers 362-366 to handle the NVMf capsules 260 (or their IO requests 262) received with respect to specific QPs 358. For instance, with respect to NVMf capsules 260 that may include commands and that may be bound for a specific one of the controllers 354, the data handling aspects 350 may return data using RDMA transport to the initiator component 264. For instance, data handling aspects 350 may include causing a response NVMf capsule to be sent for the initiator component 264. The data may be associated or may be responsive to the underlying IO request of the NVMf capsules 260.

In another example, the data handling aspects 350 can handle read for NVMf capsules 260 received for specific QPs 358. The NVMf capsules 260 may include commands for read operations and may be bound for a specific one of the controllers 354. The data handling aspects 350 may include performing an NVMe read using the storage queues 224 that are associated with the specific one of the controllers 354. Data may be returned (as responsive to the underlying IO requests of the NVMf capsules 260) to the initiator component 264 using an appropriate transport (such as RDMA write). A response NVMf capsule may also be provided to the initiator component 264 to conclude handling of the read for NVMf capsules 260.

With respect to handling write for NVMf capsules 260 received for specific QPs 358, the data handling aspects 350 may use commands of the NVMf capsules 260 and that may be bound for specific controller 354. The data handling aspects 350 may include reading data from the initiator component 264 using an appropriate transport (such as RDMA read). An NVMe or other write may be performed using the storage queues 224 that may be associated with the controller 354. A response NVMf capsule may also be provided to the initiator component 264 to conclude handling of the write for NVMf capsules 260.

In an example, RDMA target ports may be created for the storage application offloading herein. The RDMA target ports may be logical objects of the NIC 256 and may be associated with multiple QPs 358. The RDMA target ports may be associated with a single NVMf target port of the DPA 114. RDMA initiators may be identified via the NQNs and also by host machine 102 identifier attributes. A controller 354 may be identified according to a tuple that may include the NQN, the host machines NQN, a host machine identifier, an NVM subsystem port, a transport type, and a transport address. There may be multiple BEQs 224D in the data handling aspects 350. Each of the BEQs 224D may be associated with an individual one of the CQs 224A, S(R)Qs 224B, and TxQs 224C, taken independently or in combination.

The namespaces 356 may be accessed by BE group handlers 364 depending on a target's configuration. In one example, a controller 354 can access a namespace 356 using an exposed BE group handler 364. Separately, QPs 358 associated with an initiator component 264 may be able to initiate a connect fabrics command on a specific port by specifying a QID (logical queue identifier), a subsystem NQN, a host NQN, and a host identifier.

A controller 354 may be created to be associated with a QP. Before an initiator component 264 may connect to one of the controllers 354, the initiator component 264 receives all the required information, such as the subsystems, NQN, and other information described herein. This may be during a discovery phase after initiating the system 100. After the fabrics for the system 100 are connected, the initiator component 264 may begin sending request NVMf capsules 260 or IO requests 262 to the target on the associated QID, for instance. Different QPs 358 for a same RDMA target port can be associated with different subsystems 352 and with different controllers 354, as illustrated.

In one example, an initiator component 264 may create the QPs 358 and may connect them with target QPs associated with the storage queues 224. The QPs may connect to a controller 354 (using, for instance, a fabrics connect command) that belongs to an appropriate subsystem 352 that exposes an appropriate namespace 356. Then, each incoming NVMf capsule 260, upon arriving at a QP (such as using an RDMA SEND) may be placed in an associated one of the S(R)Qs 224B. Completion may be generated to the associated CQ 224A. For a read IO request, based on a QP ID retrieved from completion information in a CQ 224A, it is possible to associate the NMVf capsule 260 (via its QP) with a subsystem ID of an appropriate subsystem 352. A namespace ID of an appropriate namespace 356 may be allowed from the NVMf capsule 260. An access may be performed for a per subsystem namespace database (DB) 368.

A namespace ID may be extracted, along with a BE queue ID, from the per subsystem namespace DB 368 to access the underlying namespace 356. For a read IO request within the NVMf capsule 260, a read SQ entry may be prepared and sent to one of the S(R)Qs 224B. The sending of the read SQ entry may be part of the queue submission/scanning 308 between the DPA 114 and the storage queues 224 to support the direct communication (comm.) 304 between the DPA 114 and the storage devices 1 to N 118A-118N. For instance, both the S(R)Qs 224B and the NVMf capsule 260 may not be subject to interference or requirements from the CPU to process IO requests of the NVMf capsule 260 or any general IO requests 262 outside of the NVMf capsule 260.

In addition, while most information for such access may be taken from the NVMf capsule 260, some information may be inserted into the NVMf capsule 260. The information may be based at least in part on internal databases of the system 100. An internal database may include a database having Command Identifier (CID) information, which may be a unique number assigned to each IO command of an NVMf capsule 260 that may be submitted to storage device 118. The CID may be used to track, by the host machine 102, any correlation between IO requests 262 underlying the NVMf capsule 260 and their corresponding completions. A wait may be performed for valid entries in the CQ 224A. The wait may be based on a valid CQ entry. An associated QP ID may be resolved following the wait and after the valid CQ entry is complete. For a write, a write work queue (WQ) entry may be prepared and submitted to resolve a QP ID. A write completion may be received. A SEND WQ entry may be prepared and submitted for a response NMVf capsule transmission to be provided. A send completion may be received and post-receive actions may be performed. One post-receive action may be to release the NVMf capsule 260 from one of the S(R)Qs 224B. All such aspects may be tied to the read IO request in a NVMf capsule 260.

For a write IO request in an NVMf capsule 260, based on a QP ID retrieved from a completion information of a CQ 224A, it is possible to prepare and submit a read IO request to that QP. The NVMf capsule 260 with the write IO request may be associated with the capsule with QP ID. For instance, a metadata database. Read completions may be received and may be correlated with a completion for the NVMf capsule 260 using the metadata. A namespace ID for a namespace 356 may be obtained from the NVMf capsule 260. A per subsystem namespace DB 368 may be accessed and a BE namespace ID and a BE queue ID may be extracted for a namespace 356.

A read SQ entry may be prepared and submitted to at least one of the S(R)Qs 224B. Here too, most information shall be taken from the NVMf capsule 260. Some information may be inserted based at least in part on the internal databases. A wait for valid entries may be performed in the CQ 224A. The valid entries may be based on valid CQ entry information of the CQ 224A. The QP ID may be resolved for the QP associated with the write IO request. A SEND WQ entry for response capsule transmission may be prepared and sent. A send completion may be received and a post-receive step may be performed to release the NVMf capsule 260 from one of the S(R)Qs 224B. In at least one example, submission of a read may not be required for certain data sizes as data of such sizes (such as less than 8 KB) may be placed as part of the processing performed for an NVMf capsule 260.

Work described with respect to the write and read operations involving an NVMf capsule 260 may be split between independent parallel handlers 362-366 in the MTM pipelining configuration. In FIG. 3B, CQ group handlers 362 may include handlers that are individually responsible for handling responder CQEs (such as for incoming NVMf capsules 260). The handlers of the CQ group handlers 362 may be individually responsible for handling requester CQ entries (such as RDMA transactions) for a group of QPs 358. For incoming NVMf capsules 260, each handler of the CQ group handlers 362 may be responsible for performing transport and NVMf packet verifications and for resolving BE namespace ID and BE ID (for the storage queues 224).

When the verifications are indicated as passed, the CQ group handlers 362 can cause work to be submitted to a next handler. Otherwise, an error flow may be designated in which each handler of the CQ group handlers 362 may be associated with a single one of the S(R)Qs 224B and with a single shared CQ 224A. There may be multiple QPs 358 that may belong to various subsystems 35, as part of MTM pipelining configuration 370. The multiple QPs 358 may be associated with a handler of the CQ group handlers 362. In at least one example, a handler may not be associated with a single subsystem 352 if it has a low bandwidth. In one example, a low bandwidth may be about 0.5 Mega input-outputs per second (MIOPS). Other handlers of the CQ group handlers 362 may be available and may be assigned, instead. Each handler of the CQ group handlers 362 may be able to access all the subsystems 352.

All QPs that belong to a specific subsystem 352 may be handled by multiple handlers of the CQ group handlers 362. There may be a need to allocate enough handlers to meet the required performance (such as above 20 MIOPS). A storage application 202 may be able to uniformly distribute created QPs 358 between allocated handlers. The MTM pipelining configuration 370 may allow a reduction in a memory footprint to support 25,000 QPs 358. The MTM pipelining configuration 370 is so that multiple QPs 358 may share the same CQ resource, which allows allocation of the shared CQ in the CQ group handlers 362. The MTM pipelining configuration 370 allows memory space for the DPA to allow for fast access. In addition, the MTM pipelining configuration 370 can reduce a number of handlers in the CQ group handlers 362. There need not be a CQ assigned per QP, for instance.

The CQ group handlers 362 may be used to scan CQs 224A and to process responder and requester CQ entries. The CQ group handlers 362 may be used to perform transport and NVMf packet validations for NVMf capsules 260. The CQ group handlers 362 may also be used to access handler-dedicated QP databases (such as the aforementioned internal databases associated with the storage queues 224) and to resolve any subsystem ID requirements. The CQ group handlers 362 may be used to access a namespace DB 368 to resolve any BE namespace ID and BE ID requirements. In one example, a handler of the CQ group handlers 362 may have a local copy of a database (for performance optimization reasons). A handler of the CQ group handlers 362 may, alternatively, access a global database along with all the rest of the handlers. The use of a local or a global internal or namespace DB may depend, at least in part, on performance intended in the system 100.

In addition, for read/write and immediate NVMf capsules, as well as for read completions, a handler of the CQ group handlers 362 may be used to prepare and submit a work request for an SQ entry of a specific BEQ 224D. For write NVMf capsules, a handler of the CQ group handlers 362 may be used to prepare and submit a TX work request for transmission through the Tx group handler 366. There may be a special handler of the CQ group handlers 362 that may be designated to handle CQ entries associated with a specific port, such as a small factor or other SF port.

The BE group handlers 364 may include individual handlers that are each responsible for handling a set of BEQs 224D. Each handler of the BE group handlers 364 may be able to support a single one of the BEQs 224D but can also support several BEQs 224D. The BEQs 224D may belong to different storage devices 1 to N 118A-118N. For SQ entries, a handler of the BE group handlers 364 may receive a submission work from multiple ones of the CQ group handlers 362. Each handler of the BE group handlers 364 may prepare and submit SQ entries to an appropriate S(R)Q that may be allocated in a memory subsystem 220 of the host machine 102. After writing a bulk of the SQ entries, the handlers of the BE group handlers 364 can submit an SQ P2P doorbell to corresponding S(R)Q producer addresses.

Each handler of the BE group handlers 364 can generate a unique CID for each submitted SQ entry. Each handler of the BE group handlers 364 may be able to associate the CID with a context. A context may include, in one example, a pointer to an NVMf capsule 260, a payload, QP ID, and the like. Each handler of the BE group handlers 364 may also be responsible for CQ entry processing. For instance, after the submission of a bulk of SQ entries, each handler of the BE group handlers 364 may be able to submit a wait-on-data WQ entry that may poll on a validity of a next CQ entry to be processed. A completion may be generated when the CQ entry is valid and a corresponding handler of the BE group handlers 364 is invoked.

Each handler of the BE group handlers 364 may process CQ entries and may, based in part on a CID, fetch a context for information. Each handler of the BE group handlers 364 may be able to extract the information from a context using the CQ entry. There may be a many-to-one (MTO) mapping or configuration 372 between the CQ group handlers 362 and BE group handlers 364. The MTO configuration may be at least because different QPs 358 may belong to different CQs 224A groups of the CQ group handlers 362 and may access a same BE group queue. Each handler of the BE group handlers 364 may be able to perform round-robin (RR) scheduling between its input work queues.

The Tx group handlers 366 may include individual handlers that may each be responsible for processing transmission (such as RDMA transmission) for IO requests associated with read, write, and send (and their respective response NVMf capsules). Each handler of the Tx group handlers 366 may receive work requests from one or more connected handler or the CQ group handlers 362. The work requests may include write NVMf capsules with large IO requests. Each handler of the Tx group handlers 366 may also receive work requests from any handler of the BE group handlers 364.

For a work request, each handler of the Tx group handlers 366 may have a QP 358 associated therewith. This may mean that multiple TX group handlers 366 may not be able to submit WQ entries for a same one of the QPs 358 or this may require synchronizations to be performed. The MTM mapping or pipelining configuration 370 between BE group handlers 364 and Tx group handlers 366 may be allowed by multiple QPs 358 having access to the same BE queue. The MTM pipelining configuration between the CQ group handlers 362 and the Tx group handlers 366 allows for a reduction in a number of handlers used for the Tx group handlers 366. This may mean that several different QPs 358 may arrive on different S(R)Qs and can be processed by a same handler of the Tx group handlers 366. Each handler of the Tx group handlers 366 may be able to perform weighted RR (WRR) between its input work queues as there may be many different numbers of BE input queues input relative to individual CQ group handlers'queues. As in the case of the CQ group handlers, there may be a special handler of the Tx group handlers 366 that may be designated to handle CQ entries associated with a specific port, such as a small factor or other SF port.

Therefore, the MTM pipelining configuration 370 may be so that messages passed between handlers 362-366 use inter-thread communication S/W queues. For instance, CQ group handlers 362 may be associated with a group of QPs 358 that can access any subsystem 352 and any namespace 356. The CQ group handlers 362 can manage shared CQs 224A and S(R)Qs 224B. The CQ group handlers 362 can also handle responses (via the response NVMf capsules in NVMf completions) and via response CQ entries (in RDMA completions). The CQ group handlers 362 can resolve NVMe BE and can submit work to the BE group handlers 364. Separately, if an RDMA read is needed, the CQ group handlers 362 can submit work to the Tx group handlers 366. For its part, the BE group handlers 364 may be NVMe-specific. The BE group handlers 364 may be associated with the S(R)Qs and CQs to prepare and submit SQ entries and to secure database information using the kernel-based P2P process 228. The BE group handlers 364 can also scan the CQ entries and can submit its database information using the kernel-based P2P process 228. The BE group handlers 364 can also submit Tx work to the Tx group handlers 366. The Tx group handlers 366 may be associated with a group of QPs 358 and may be able to receive Tx work requests for associated QPs 358 from the BE group handlers 364. The Tx group handlers 366 can submit WQ entries to allow the transmission of data responsive to the IO requests or NVMf capsules.

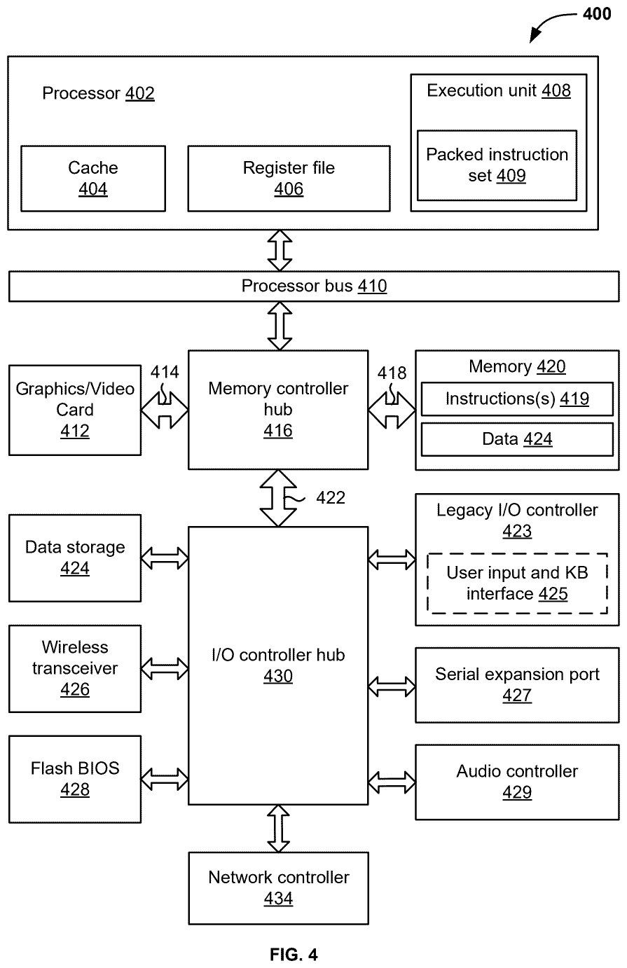

FIG. 4 illustrates computer and processor aspects 400 of a system for storage application offload using a DPA in communication with a kernel-based P2P process, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, GPUs, and DPUs. At least one of the DPUs may be configured for storage application offload using a DPA in communication with a kernel-based P2P process.

In at least one embodiment, the computer and processor aspects 400 may include, without limitation, a component, such as a processor 402 to employ execution units including logic to perform algorithms for process data, in accordance with the present disclosure, such as in the embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), a system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1A-3B and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in the computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data storage 424 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418, and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas, in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

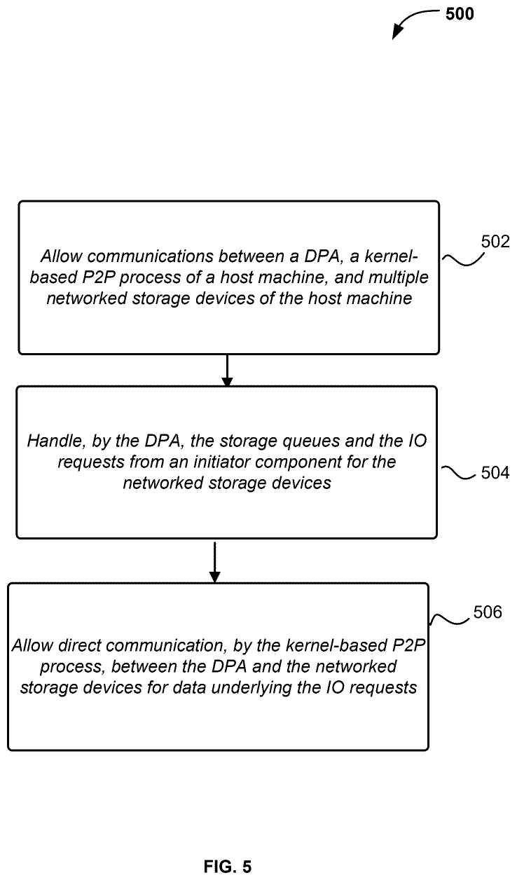

FIG. 5 illustrates a process flow or method 500 in a system for storage application offload using a DPA in communication with a kernel-based P2P process, according to at least one embodiment. The method 500 may include a step to allow 502 communications between a DPA, a kernel-based P2P process of a host machine, and multiple networked storage devices of the host machine. This step may be supported by at least the communications established using the discussions in FIGS. 1A-2A. The step to allow 502 communications may be performed, in part, by one or more of the initializations and the discovery phases performed for a system 100 for storage application offload as described in one or more of FIGS. 1A-4 herein. The method 500 may include determining or verifying that storage queues or IO requests are to be addressed in the system 100. For instance, completion of the initialization and the discovery phases may be confirmed in this step. The method 500 may include a step to handle 504, by the DPA, the storage queues and the IO requests from an initiator component for the networked storage devices.

The method 500 may include a step to allow 508 direct communication, by the kernel-based P2P process, between the DPA and the networked storage devices for data underlying the IO requests. In one example, the step to handle 504 the storage queues and the IO requests may include aspects of queue submission and queue scanning for the storage queues based in part on IO requests received at a NIC associated with the DPA. As the DPA may handle queue submission and queue scanning, as part of this step 504, without interference or interaction with a CPU, there is direct communication allowed 508 and established between the DPU and the storage devices for the IO requests.

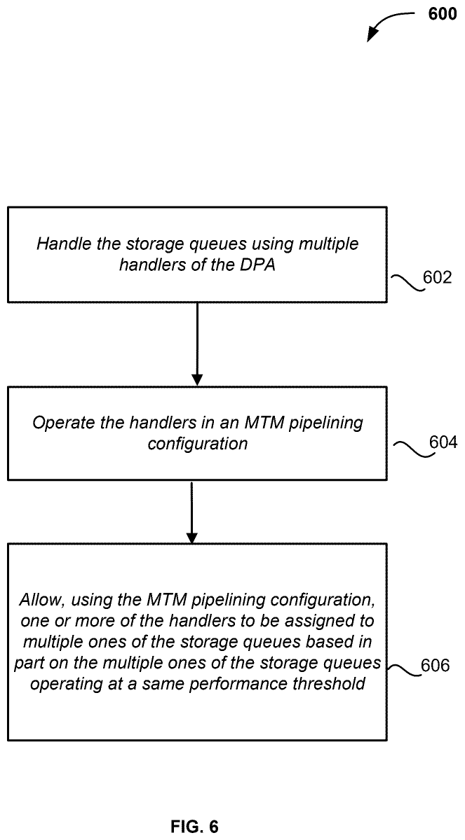

FIG. 6 illustrates yet another process flow or method 500 in a system for storage application offload using a DPA in communication with a kernel-based P2P process, according to at least one embodiment. The method 600 may work in conjunction or independent of the method 500 in FIG. 5. The method 600 in FIG. 6 may include a step to handle 602 the storage queues using multiple handlers of the DPA. The method 600 may include a step to operate 604 the handlers in an MTM pipelining configuration. A determination or verification may be made that assignment is required in the method 600. The assignment may be between handlers and the storage queues and may be required based on determination or verification that handlers are operating at a same or similar Tx handler speed, that queues are operating at a same or similar transmission queue speed or are at a same or similar completion speed. Alternatively, the assignment may be required by an intended configuration in the initialization and discovery performed for the system 100 for storage application offload. The method 600 may include a step to allow 606, using the MTM pipelining configuration, one or more of the multiple handlers to be assigned to multiple ones of the storage queues based in part on the multiple ones of the storage queues operating at a same performance threshold.

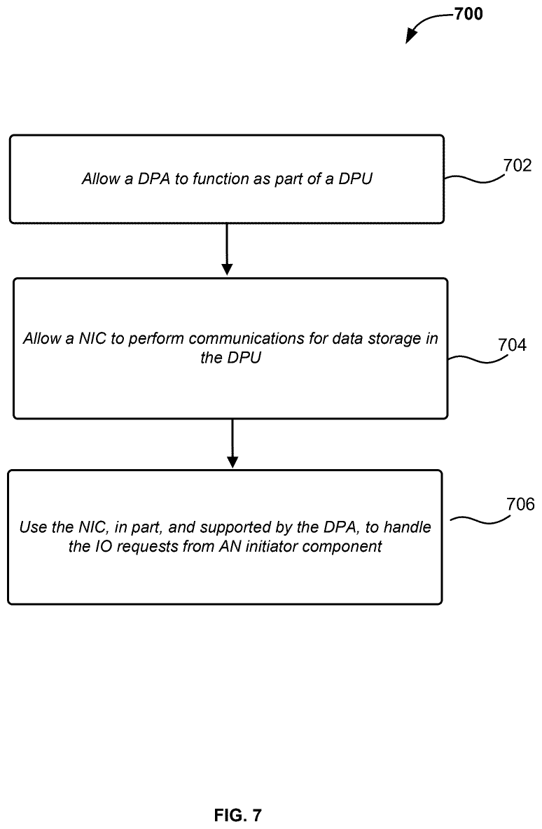

FIG. 7 illustrates a further process flow or method 700 in a system for seamless offload of workload to DPUs based, at least in part, on capabilities associated with a selected first one of the DPUs being within a threshold, according to at least one embodiment. The method 600 may work in conjunction or independent of the methods 500, 600 in FIGS. 5 and 6. The method 700 in FIG. 7 may include a step to allow 702 the DPA to function as part of a DPU, as detailed in at least FIGS. 1A-2A. In one instance, this step may be performed, in part, during initialization or discovery phases of the system 100. The DPA being loaded with a DPA API to handle queue submission and queue scanning without interference or interaction with a CPU may be part of the step to allow 702 the DPA to function as part of the DPU in the method 700. The method 700 may include a step to allow 704 a NIC to perform communications for data storage in the DPU. The NIC may be allowed 704 to do so, in part, by allowing database fetches and completions to be handled between the NIC and the DPU. A verification or determination may be performed in the method 700 to check that IO requests are received. The verification or determination may be part of the protocol for the type of IO requests. The method may include a step to use 708 the NIC, in part, and supported by the DPA, to handle the IO requests from an initiator component without need for CPU interference.

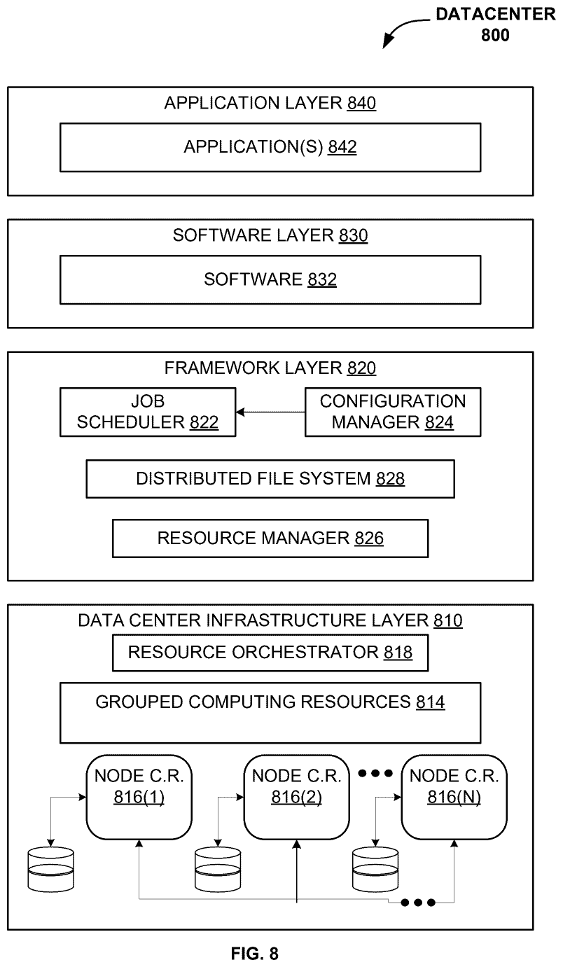

FIG. 8 illustrates an example datacenter 800 to apply at least one embodiment in FIGS. 1A-7. In at least one embodiment, datacenter 800 includes a datacenter infrastructure layer 810, a framework layer 820, a software layer 830, and an application layer 840. The example datacenter 800 may allow storage application offloading in a DPA 114 and may allow the DPA 114, as a subsystem of a DPU 104, to perform certain storage-related tasks otherwise handled by a CPU 108, as described in FIGS. 1A-7. The datacenter 800 may include circuit boards having processors (such as CPUs, GPUs, DPUs, or the like (also described as node computing resources (node C.R.s 816(1)-816(N)), and other compute devices described with respect to the data infrastructure layer 810. Aspects of the storage application offloading in a DPA 114 and may allow other processors, as a subsystem of a DPU 104, to perform certain storage-related tasks otherwise handled by a CPU 108, as also described in FIGS. 1A-7.

In at least one embodiment, as shown in FIG. 8, datacenter infrastructure layer 810 may include a resource orchestrator 818, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in datacenters at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 818 may configure or otherwise control one or more node C.R.s 816(1)-816(N) and/or grouped computing resources 814. In at least one embodiment, resource orchestrator 818 may include a software design infrastructure (“SDI”) management entity for datacenter 800. In at least one embodiment, resource orchestrator 818 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of datacenter 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at datacenter infrastructure layer 810. In at least one embodiment, resource manager 826 may coordinate with resource orchestrator 818 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 818 may implement any number and type of self-modifying actions based on any amount and type of data acquired in any technically feasible fashion. In at least one embodiment, self-modifying actions may relieve a datacenter operator of datacenter 800 from making possibly bad configuration decisions and possibly avoiding underused and/or poor performing portions of a datacenter.

In at least one embodiment, datacenter 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 800. In at least one embodiment, trained machine learning models corresponding to one or more neural networks may be used to infer or predict information using resources described above with respect to datacenter 800 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A data-path accelerator (DPA) in communication with a kernel-based peer to peer (P2P) process of a host machine and also in communication with a plurality of networked storage devices, wherein the DPA handles storage queues and input-output (IO) requests from an initiator component for the plurality of networked storage devices, and wherein the kernel-based P2P process allows direct communication between the DPA and the plurality of networked storage devices for data underlying the IO requests.

2. The DPA of claim 1, further comprising a plurality of handlers to handle the storage queues, wherein the plurality of handlers operates in a many-to-many (MTM) pipelining configuration, and wherein the MTM pipelining configuration allows one or more of the plurality of handlers to be assigned to multiple ones of the storage queues based in part on the multiple ones of the storage queues operating at a same performance threshold.

3. The DPA of claim 1, further comprising a plurality of handlers that is allowed or supported by a software library of the host machine, the plurality of handlers to handle the storage queues.

4. The DPA of claim 1, wherein the DPA is within a data processing unit (DPU) that is independent of a central processing unit (CPU) of the host machine.

5. The DPA of claim 1, wherein the DPA is part of a first data processing unit (DPU) that is further in communication with a staging buffer of the host machine to handle data associated with the IO requests, the staging buffer and the storage queues being associated with a central processing unit (CPU) or a second DPU of the host machine.

6. The DPA of claim 1, wherein the DPA is part of a data processing unit (DPU) comprising a network interface card (NIC) to allow, in part, the DPA to handle the IO requests from the initiator component.

7. The DPA of claim 1, wherein the networked storage devices, the DPA, and the host machine are part of a peripheral component interconnect (PCI) bus to allow the DPA, the kernel-based P2P process, and the plurality of networked storage devices to be in the communication.

8. A system for offloading memory management, comprising:
a data-path accelerator (DPA) to handle storage queues and input-output (IO) requests for a plurality of networked storage devices; and
a kernel-based peer to peer (P2P) process, of a host machine, to allow direct communication between the DPA and the plurality of networked storage devices for data underlying the IO requests.

9. The system of claim 8, further comprising one or more of:
a plurality of handlers in the DPA to handle the storage queues, wherein the plurality of handlers operates in a many-to-many (MTM) pipelining configuration, wherein the MTM pipelining configuration allows one or more of the plurality of handlers to be assigned to multiple ones of the storage queues based in part on the multiple ones of the storage queues operating at a same performance threshold; or
the plurality of handlers allowed or supported by a software library of the host machine and allowed within the DPA to handle the storage queues in the M2M pipelining configuration.

10. The system of claim 8, further comprising one or more of:
a first data processing unit (DPU) to comprise therein the DPA, the DPU in communication with a staging buffer of the host machine to handle data associated with the IO requests, the staging buffer and the storage queues being associated with a central processing unit (CPU) or a second DPU of the host machine; or
a data processing unit DPU to comprise therein the DPA, the DPU also comprising a network interface card (NIC) to allow, in part, the DPA to handle the IO requests from an initiator component.

11. The system of claim 8, further comprising:
a peripheral component interconnect (PCI) bus to allow the DPA, the kernel-based P2P process, and the plurality of networked storage devices to be in the communication.

12. A plurality of circuits to handle, on behalf of a central processing unit (CPU), storage queues and input-output (IO) requests associated with a plurality of networked storage devices, based in part on a kernel-based P2P process for direct communication between the plurality of circuits and the plurality of networked storage devices for data underlying the IO requests.

13. The plurality of circuits of claim 12, further comprising:
a plurality of handlers in the DPA to handle the storage queues, wherein the plurality of handlers operates in a many-to-many (MTM) pipelining configuration, wherein the MTM pipelining configuration allows one or more of the plurality of handlers to be assigned to multiple ones of the storage queues based in part on the multiple ones of the storage queues operating at a same performance threshold.

14. The plurality of circuits of claim 12, further comprising one or more of:
a first data processing unit (DPU) to comprise therein the DPA, the DPU in communication with a staging buffer of the host machine to handle data associated with the IO requests, the staging buffer and the storage queues being associated with a central processing unit (CPU) or a second DPU of the host machine; or
a data processing unit DPU to comprise therein the DPA, the DPU also comprising a network interface card (NIC) to allow, in part, the DPA to handle the IO requests from an initiator component.

15. A method for storage application offload, comprising:
allowing communications between a data-path accelerator (DPA), a kernel-based peer to peer (P2P) process of a host machine, and a plurality of networked storage devices;
handling, by the DPA, storage queues and input-output (IO) requests from an initiator component for the plurality of networked storage devices; and
allowing direct communication, by the kernel-based P2P process, between the DPA and the plurality of networked storage devices for data underlying the IO requests.

16. The method of claim 15, further comprising:
handling the storage queues using a plurality of handlers of the DPA;
operating the plurality of handlers in a many-to-many (MTM) pipelining configuration; and
allowing, using the MTM pipelining configuration, one or more of the plurality of handlers to be assigned to multiple ones of the storage queues based in part on the multiple ones of the storage queues operating at a same performance threshold.

17. The method of claim 15, further comprising one or more of:
allowing or supporting a plurality of handlers using a software library of the host machine, the plurality of handlers to handle the storage queues; or
allowing the DPA to function within a data processing unit (DPU) that is independent of a central processing unit (CPU) of the host machine.

18. The method of claim 15, further comprising:
associating a staging buffer and the storage queues with a central processing unit (CPU) or a data processing unit (DPU) of the host machine; and
handling data associated with the IO requests using the staging buffer, wherein the DPA is part of a different DPU that is in communication with the staging buffer.

19. The method of claim 15, further comprising:
allowing the DPA to function as part of a data processing unit (DPU);
allowing a network interface card (NIC) to perform the communications in the DPU; and
using the NIC, in part and by the DPA, to handle the IO requests from the initiator component.

20. The method of claim 15, further comprising:
allowing the communications for the DPA, the kernel-based P2P process, and the plurality of networked storage devices using a peripheral component interconnect (PCI) bus.
